(19) United States
(12) Patent Application Publication
(10) Pub. No.: US 2012/0021096 A1
(43) Pub. Date: Jan. 26, 2012

(54) NEW ENVIRONMENTALLY FRIENDLY FOOD PRODUCTS AND METHODS TO PRODUCE THEM

(76) Inventor: Pirjo ALHO-LEHTO, Vanhalinna (FI)

(21) Appl. No.: 13/238,888

(22) Filed: Sep. 21, 2011

Related U.S. Application Data
(63) Continuation of application No. PCT/FI2010/000025, filed on Apr. 15, 2010.

(30) Foreign Application Priority Data
Apr. 15, 2009 (FI) 20090142

(51) Int. Cl. A23L 1/00; A23C 9/00; A23L 1/31; A23L 1/325; B42D 15/00; A23P 1/00; B65D 85/80; B65B 25/06; B65B 25/02; B65D 85/00; A23L 1/32

(52) U.S. Cl. 426/87; 426/665; 426/392; 426/531; 426/383; 283/67

(57) ABSTRACT

The invention relates to reducing or minimising the environmental footprint comprising a water footprint and a carbon footprint of a food product.

### FIELD OF INVENTION

The invention relates to food manufacturing and especially to new methods related to producing food products and new food products.

### BACKGROUND OF THE INVENTION

Environmental questions are becoming more important in industry. There is therefore a need for more environmentally friendly food products and methods of preparing them.

Threat of global warming and public discussion thereof has already resulted in actions by some players in the industry. The discussion and actions have mainly been focused on how to reduce carbon dioxide (CO₂) release (footprint) caused during the whole lifecycle of the food product or some part of it, e.g. during the industrial processing. Product labels with information on CO₂ footprint have been taken into use recently.

CO₂ is only one of the so called greenhouse gases which are accused for the global warming the others being e.g. methane (CH₄), nitrogen oxides (especially nitrous oxide i.e. N₂O), hydrofluorocarbons (HFC), perfluorocarbons (PFC) and sulfur hexafluoride (SF₆). Thus, minimizing the CO₂ footprint of a food product could in some cases result in a worse overall environmental effect if the release of these other greenhouse gases is increased at the same time. Therefore, the industry has started to calculate and use the term carbon footprint which includes releases of all greenhouse gases. Hereby, the carbon footprint includes both the CO₂ footprint and that caused by other greenhouse gases converted to CO₂. This overall effect has been named CO₂ equivalent (CO₂e) footprint.

The carbon footprint is not the only environmental footprint and perhaps not even the most important, at least in some parts of the world. It might happen that minimising the carbon footprint is harmful to one or several of these other footprints even to such extend that the overall effect is negative to the environment.

One of these other environmental footprints is the water footprint of the food product. Also that can be calculated for the whole life cycle of the food product or for some part of it, e.g. water consumption during the industrial processing of the raw materials to manufacture the food product.

### SUMMARY OF THE INVENTION

The present invention provides a method of reducing the environmental footprint of a food product.

The invention also provides a method of minimising the environmental footprint of a food product.

The invention further provides a food product package.

The invention still further provides a method to inform the environmental footprint of a food product.

The invention even further provides a method to guide a consumer to an environmentally friendly selection of a food product.

The characterising features of the present invention are set forth in the claims.

### DETAILED DESCRIPTION OF THE INVENTION

Carbon footprint (CO₂e) is understood here as the release of all greenhouse gases calculated to CO₂ during the steps of production and processing of the raw materials, manufacture and packaging of the food product and logistics relating to all these steps. Thus the carbon footprint includes CO₂e from all the steps of the life cycle until the product is available to the consumer. The carbon footprint may be calculated using the guidelines of ISO 14040 and ISO 14044. It is expressed as g CO₂ equivalents produced per 100 g final food product.

Likewise, water footprint is understood here as consumption of freshwater resources during all the same steps as mentioned above until the product is put on sale to the consumer. The consumption of freshwater includes blue, green and gray water components of the water footprint. The blue water footprint means the volume of surface and ground water used. The green water footprint relates to the evaporation of rainwater stored in the soil during growing of plant based raw materials of the product or intermediates thereof The grey water footprint is the volume of waste water produced. With the water footprint of a product is here meant the same as defined in Value of Water Research Report Series No. 27 by UNESCO-IHE (P. W. Gerbens-Leenes and A. Y. Hoekstra, March 2008). The water footprint is here expressed as g freshwater used per 100 g final food product.

The carbon and the water footprint are here called environmental footprints.

Surprisingly, it was discovered that one should not from an environmental point of view reduce one environmental footprint of a product without taking into consideration the effect of the measures to the other footprint. E.g. in some cases it is possible to reduce both the carbon and water footprint at the same time. However, very often a reduced carbon footprint results in an increased water footprint and vice versa. In both cases one should select measures which have the best overall environmental effect.

To evaluate the water and CO₂e footprints one has to calculate them for the food product during its whole life cycle from producing raw materials to final food product at the shelves of the stores. These steps can be grouped into production and processing of the raw materials, manufacturing of the food product, packaging and logistics related to any of the mentioned steps. The effect of the logistics can sometimes alternatively or partly be included in one or several of the other steps.

If the raw material is a plant the production step involves growing the plant and all measures involved in that step including e.g. planting, providing water, harvesting, liming, fertilising, pesticiding, and the use of any machineries in these processes. The chain also includes production of the chemicals used. Often any needed transportations are included. The CO₂e footprint can be optimised by regulating the use of chemicals in relation to the volume of the obtained harvest. The use of fresh water cannot much be regulated as rainwater is included in the calculations. However, if only the footprint of blue water is evaluated one should preferably choose a geographical location where it is not necessary to irrigate but there is available enough of rainwater. Irrigation, in addition to increasing the blue water footprint, increases also the carbon footprint as it needs energy and machinery. The use of blue water footprint would therefore more accurately be related to the impact of the world's water resources than the use of the total freshwater footprint, at least at locations where there is excess of rainfall.

If the raw material is e.g. meat one has to evaluate the whole chain of processes and products to obtain the meat including e.g. the growing of plants for feeding the animals.

The food industry is itself mainly involved in the processing of raw materials and manufacturing of the food product. However, the industry nowadays needs to look at the whole chain in order to be able to evaluate the product total environmental footprint the food product sets on the globe.

Processing of the raw materials and manufacturing the food product involves processes wherein one could try to reduce the amount of freshwater used. Most of the water in food industry is used for washing. One would therefore try to develop a process including re-circulation of at least part of the water. This would also lead to a smaller production of grey water. Other or additional measures could be trying to use elevated temperatures and pressures in the processes to reduce the amount of freshwater used. All these steps however would lead to an increased need for energy and thus to a bigger CO₂e footprint. Therefore, it is vital according to the invention to not only minimize the water footprint but also to take into account the effect the planned changes has on the CO₂e footprint and then choose the measures having the best possible environmental footprint.

On the other hand, one could try to reduce the CO₂e footprint in the processing of raw materials and manufacturing of food products by reducing the temperature, the pressure and/or the amount of re-circulation of water, if present. These steps would however lead to increased use of freshwater and a bigger water footprint. Again, both the water and the CO₂e footprint has to be taken into account in order to obtain a possible sustainable solution from an environmental point of view.

Instead or in addition to the total water footprint one could evaluate the grey water footprint to even more exactly present the use of water resources.

The food product package's footprints are also included in the calculation of the footprints of the food product according to this invention. By choosing e.g. suitable package materials, printing inks and package sizes both the water and the CO₂e footprints can be taken into account to obtain an environmentally friendly package.

Logistics i.e. transportations are also noticed in the footprints according to this invention. Transportation mainly affects the CO₂e footprint. Vehicles with low CO₂e footprint should therefore preferably be used.

It was now also realised that the consumers should be aware of both the water and the CO₂e footprint of food products in order for them to be able to make a choise of an environmentally friendly product. Thus, the methods according to the invention to reduce or minimise the environmental footprint of food products works in the following way: The consumer prefers to choose food products with a small environmental footprint and therefore the sales of such products will increase. This will lead to a development and production of food products with still smaller environmental footprints. This information should advantageously be presented on the food product package. Preferably information of the nutritional value of the food product is also present on the package label.

When e.g. starting with a risotto food product it was noticed that the rice had a big water footprint and it was then looked for alternative raw materials with an acceptable, preferably about the same or more preferably even a better nutritional value than rice, and a raw material from which the same type of food product could be produced. When comparing e.g. barley's water footprint to that of rice (world average: 1388 resp. 2975 m3/ton) barley was found much more environmentally friendly. The nutritional value of barley is about the same as for rice or even a little better. Rice has also a big CO₂e footprint, e.g. a package of Italian rice has 290 g CO₂e/100 g, whereas Swedish barley only has 59 g CO₂e/100 g. Therefore, by substituting rice to barley in a risotto food product a remarkable reduction also of the CO₂e footprint can be obtained. Thus, replacing rice with barley leads to a food product with a better, i.e. a smaller environmental footprint.

From the carbon footprint point of view one could be tempted to replace soy with oat in a drink. On the other hand, oat preferably needs enzymatic treatment whereas soybeans only are extracted with water. Therefore, it has to be evaluated if the processing of oats requires more water than the processing of soybeans and if this bigger amount of water leads to a worse or better total impact on the environment taking into account the carbon footprint effects of the two product alternatives. Thus, the environmentally friendly solution might even be a new product with both oat and soy.

Malt production includes several immersions of barley grains under water (“steeping”). One could try to reduce the water footprint by circulating the drained water after the immersions. However, calculations show that actions needed to purify the water to an acceptable level would result in a huge increase in the carbon footprint. Here, the invention helps to avoid implementing an environmentally unhealthy solution.

Food grade rapeseed oil has to be raffinated. In that process frequent washing of screens is needed. Calculations showed that a minor increase in pressure and temperature of the washing water would result in a 20-30% reduction of the water volume. Also the use of washing chemicals could be decreased. In this way, the water footprint could be remarkably reduced without significantly increasing the carbon footprint.

Here is disclosed a method of reducing the environmental footprint comprising a water footprint and a carbon footprint of a food product comprising
choosing factors influencing the water footprint of the food product,
choosing factors influencing the carbon footprint of the food product,
calculating the water footprint of the factors influencing the water footprint and summing them to the water footprint of the food product,
calculating the carbon footprint of the factors influencing the carbon footprint and summing them to the carbon footprint of the food product,
   characterised in that the environmental footprint is reduced by
publishing the water footprint and optionally the carbon footprint of the food product, preferably on a food product label and/or
adjusting, replacing, adding or removing one or several of the factors influencing the water and/or the carbon footprint.

The invention relates to a method of reducing the environmental footprint comprising a water footprint and a carbon footprint of a food product comprising
choosing factors influencing the water footprint of the food product,
choosing factors influencing the carbon footprint of the food product,
calculating the water footprint of the factors influencing the water footprint and summing them to the water footprint of the food product,
calculating the carbon footprint of the factors influencing the carbon footprint and summing them to the carbon footprint of the food product,
   characterised in that the environmental footprint is reduced by
converting the carbon and water footprint of the food product to same unit, and
adjusting, replacing, adding or removing one or several of the factors influencing the water and/or the carbon footprint in order to reduce the environmental footprint.

In other words, the invention discloses a method in which all environmental footprints of a food product are first converted to same unit and thereafter summarized and this total footprint is finally reduced. Thus e.g. the water and the carbon footprint of the food product are first made commensurable and their sum is thereafter reduced, e.g. by adjusting, replacing, adding or removing one or several factors influencing the water and/or the carbon footprint. A preferred means to make water and carbon footprint commensurable is to use local cost of freshwater, in practice cost of blue and/or grey water, and carbon tax (environmental tax on emissions of carbon dioxide) in the calculations.

The invention also relates to a method of minimising the environmental footprint comprising a water footprint and a carbon footprint of a food product comprising
choosing factors influencing the water footprint of the food product,
choosing factors influencing the carbon footprint of the food product,
calculating the water footprint of the factors influencing the water footprint and summing them to the water footprint of the food product,
calculating the carbon footprint of the factors influencing the carbon footprint and summing them to the carbon footprint of the food product,
   characterised in that the environmental footprint is minimised by
setting an upper limit for the carbon footprint or the water footprint, and
adjusting, replacing, adding or removing one or several of the factors influencing the water and/or the carbon footprint in order to minimise the environmental footprint in such a way that the set limit is not exceeded.

In other words, the invention discloses a method in which an upper limit is set for at least one of the environmental footprints of a food product and the sum of the rest of the footprints is then minimised in such a way that the set limits are not exceeded. Thus e.g. an upper limit is set for the carbon footprint of the food product (e.g. 100 g CO₂e/100 g food product) and then the water footprint of the food product is minimised, e.g. by adjusting, replacing, adding or removing one or several factors influencing the water footprint in such a way that the set limit for the carbon footprint is not exceeded.

One example of minimising the environmental footprint is a method in which an upper limit is set for one of the environmental footprints of a food product which set limit is above a current value and then the rest of the footprints are minimised in such a way that the set limit is not exceeded.

Another example of minimising the environmental footprint is a method in which an upper limit is set for one of the environmental footprints of a food product which footprint needs to be reduced in order not to exceed the set limit and then the rest of the footprints are minimised in such a way that the set limit is not exceeded.

In the method also publishing the carbon footprint of the food product on the food product label is preferred. The environmental footprint can preferably be reduced by replacing, adding or removing one or several of the factors influencing the water and/or the carbon footprint, preferably of one or several factors influencing both the water footprint and the carbon footprint.

In the method the carbon footprint of the food product comprises the CO₂ footprint and optionally the converted CO₂ equivalent (CO₂e) footprint of the greenhouse gases, preferably of CO₂, CH₄, and nitrogen oxides (especially N₂O).

In the method preferably the factors influencing the water and/or the carbon footprint comprise production and optional processing of the raw materials, manufacture of the food product, optional packaging of the food product and logistics.

In the method the production preferably comprises growing at least one raw material, more preferably selected from the group consisting of cereals, vegetables, fruits, berries, beets, legume, and oil plants, most preferably of cereals selected from the group of oat, barley, wheat and rye. The production may also include the manufacturing of milk, meat, fish or egg.

In the method the packaging preferably comprises manufacture of packaging materials and the package as well as transportation thereof.

In the method the logistics preferably comprises transportation of the raw materials and of the packed food product.

The growing of at least one raw material may further include
the steps of planting, providing water and harvesting,
optionally at least one step of liming, fertilizing, pesticiding, and drying, and
the use of machinery in any one of these steps.

In the method the step of providing water preferably comprises irrigation and/or raining, more preferably irrigation.

The method preferably further comprises
setting a target nutritional value for the food product,
choosing raw materials available for the food product,
choosing such a combination of raw materials which meets the target nutritional value for the food product,
calculating the obtained nutritional value, and
publishing the obtained nutritional value, preferably on a food product label.

The invention also relates to a food product package comprising printed information of the nutritional value, the water footprint and the carbon footprint of the food product.

The invention also relates to a method to inform the environmental footprint of a food product comprising publishing the water and the carbon footprint of the food product, preferably on a food product label.

The invention also relates to a method to guide a consumer to an environmentally friendly selection of a food product by providing information of the nutritional value, the water footprint and the carbon footprint of the food product, preferably on a food product package.

The invention further relates to a new food product produced by taking into consideration both its water and carbon footprint.

The following examples illustrate the present invention without limiting it.

### EXAMPLE 1

Water Footprint of Rolled Oats

The water footprint of rolled oats was calculated from the following factors:

| | |
|---|---|
| Growing of oats in Finland (rainwater) | 100.6 l water/100 g rolled oats |
| Manufacture of rolled oats (steam) | 0.025 l water/100 g rolled oats |
| Package | 0.16 l water/100 g rolled oats |

The water footprint was therefore 1011/100 g rolled oats.

### EXAMPLE 2

Water Footprint of an Oat Drink

Growing and production of rolled oats produces a water footprint of 100.61/100 g rolled oats as can be seen in Example 1.15 g of rolled oats was used for producing 100 g oat drink, which gives a water footprint of 15.11/100 g drink. For the manufacture of the drink there was used 1.381 water/100 g drink, which consisted of water used for washing and the water in the product itself The drink was packed in Tetras which produced a water footprint of 0.121/100 g drink. The water footprint of the final oat drink was therefore 16.61/100 g drink.

### EXAMPLE 3

CO₂e Footprint of Rolled Oats

The CO₂e footprint of 100 g rolled oats was calculated from the following factors:

| | |
|---|---|
| Growing of oats in Finland | 64.8 g |
| Manufacture of rolled oats | 4.8 g |
| Package | 5.4 g |
| Logistics | 4.9 g |

The CO₂e footprint was therefore 80 g/100 g rolled oats.

When planning a new food product or a possible modification of a food product the raw materials and their processing should according to this invention be evaluated taking into account different factors having an impact on the water footprint and also the factors having an impact on the CO₂ or CO₂e footprint.

1. A method of reducing the environmental footprint comprising a water footprint and a carbon footprint of a food product comprising
choosing factors influencing the water footprint of the food product,
choosing factors influencing the carbon footprint of the food product,
calculating the water footprint of the factors influencing the water footprint and summing them to the water footprint of the food product,
calculating the carbon footprint of the factors influencing the carbon footprint and summing them to the carbon footprint of the food product,
characterised in that the environmental footprint is reduced by
converting the carbon and water footprint of the food product to same unit, and
adjusting, replacing, adding or removing one or several of the factors influencing the water and/or the carbon footprint in order to reduce the environmental footprint.

2. A method of minimising the environmental footprint comprising a water footprint and a carbon footprint of a food product comprising
choosing factors influencing the water footprint of the food product,
choosing factors influencing the carbon footprint of the food product,
calculating the water footprint of the factors influencing the water footprint and summing them to the water footprint of the food product,
calculating the carbon footprint of the factors influencing the carbon footprint and summing them to the carbon footprint of the food product,
characterised in that the environmental footprint is minimised by
setting an upper limit for the carbon footprint or the water footprint, and
adjusting, replacing, adding or removing one or several of the factors influencing the water and/or the carbon footprint in order to minimise the environmental footprint in such a way that the set limit is not exceeded.

3. The method according to claim 1 or 2 characterised in that comprising publishing the water and/or the carbon footprint of the food product, preferably on a food product label and most preferably publishing the water and the carbon footprint of the food product on a food product label.

4. The method according to claim 1 characterised in that adjusting, replacing, adding or removing one or several of the factors influencing both the water footprint and the carbon footprint.

5. The method according to claim 1 characterised in that the carbon footprint of the food product comprises the CO₂ footprint and optionally the converted CO₂ equivalent (CO₂e) footprint of the greenhouse gases, preferably of CO₂, CH₄ and N₂O.

6. The method according to claim 1 characterised in that the factors influencing the water and/or the carbon footprint comprise production and optional processing of the raw materials, manufacture of the food product, optional packaging of the food product and logistics.

7. The method according to claim 6 characterised in that the production comprises growing at least one raw material, preferably selected from the group consisting of cereals, vegetables, fruits, berries, beets, legume, and oil plants, most preferably of cereals selected from the group of oat, barley, wheat and rye.

8. The method according to claim 6 characterised in that the production comprises the manufacturing of milk, meat, fish or egg.

9. The method according to claim 6 characterised in that the packaging comprises manufacturing of packaging materials and the package as well as transportation thereof.

10. The method according to claim 6 characterised in that the logistics comprises transportation of the raw materials and of the packed food product.

11. The method according to claim 7 characterised in that the growing comprises
the steps of planting, providing water and harvesting,
optionally at least one step of liming, fertilizing, pesticiding, and drying, and
the use of machinery in any one of these steps.

12. The method according to claim 11 characterised in that the step of providing water comprises irrigation and/or raining, preferably irrigation.

13. The method according to claim 1 characterised in that it further comprises
setting a target nutritional value for the food product,
choosing raw materials available for the food product,
choosing such a combination of raw materials that meets the target nutritional value for the food product,
calculating the obtained nutritional value, and
publishing the obtained nutritional value, preferably on a food product label.

14. A food product produced by taking into consideration both its water and carbon footprint according to claim 1.

15. A food product package comprising the food product according to claim 14 and printed information of the nutritional value, the water footprint and the carbon footprint of the food product.

16. A method to inform the environmental footprint of the food product according to claim 14 comprising publishing the water and the carbon footprint of the food product, preferably on a food product label.

17. A method to guide a consumer to an environmentally friendly selection of a food product according to claim 14 by providing information of the nutritional value, the water footprint and the carbon footprint of the food product, preferably on a food product package.
